(19) United States
(12) Patent Application Publication
(10) Pub. No.: US 2019/0311863 A1
(43) Pub. Date: Oct. 10, 2019

(54) KEY STRUCTURE AND METHOD FOR MANUFACTURING THE SAME

(71) Applicant: Cheng Uei Precision Industry Co., Ltd., New Taipei City (TW)

(72) Inventors: ZHI-BIN DONG, Dong-Guan City (CN); FENG ZHU, Dong-Guan City (CN); KAI-HSIANG CHANG, New Taipei City (TW)

(21) Appl. No.: 15/945,607

(22) Filed: Apr. 4, 2018

(51) Int. Cl. H01H 3/12; B29C 70/84

(52) U.S. Cl. CPC H01H 3/122; H01H 2235/018; B29C 70/845

(57) ABSTRACT

A key structure includes two key bodies and two elastic pieces. The two key bodies are disposed face to face. Each of the two key bodies has a base portion. Two opposite ends of the base portion extend sideward towards a same direction to form two extending portions spaced from each other. The two extending portions of one of the two key bodies face to the two extending portions of the other key body, respectively. Two opposite ends of each of the two elastic pieces are fastened in the two extending portions of the two key bodies respectively.

### BACKGROUND OF THE INVENTION

### 1. Field of the Invention

The present invention generally relates to a key structure, and more particularly to a key structure having a simple manufacturing process and capable of realizing a continuous automation, and a method for manufacturing the same.

### 2. The Related Art

Referring to FIG. 6 and FIG. 7, a conventional key structure 100′ is of a rectangular frame shape. The conventional key structure 100′ includes two U-shaped key bodies 10′ disposed face to face. Two facing sides of the two key bodies 10′ are recessed oppositely to form two mouths 101′ facing to each other. Each of the two key bodies 10′ has a base portion 11′. Two opposite ends of the base portion 11′ of each of the key bodies 10′ extend sideward towards a same direction to form two extending portions 12′ spaced from each other. The two extending portions 12′ of one of the key bodies 10′ face to the two extending portions 12′ of the other key body 10′, respectively. Each two extending portions 12′ of the two key bodies 10′ are integrated with each other by virtue of an elastic connecting portion 20′ being integrally molded between each two extending portions 12′ of the two key bodies 10′, so that the two key bodies 10′ and the elastic connecting portion 20′ form a frame shape. The elastic connecting portion 20′ is made of a flexible soft plastic material.

However, the two key bodies 10′ and the elastic connecting portion 20′ are made of different materials, when the conventional key structure 100′ is manufactured, the two key bodies 10′ needs to be respectively molded in advance, and then the elastic connecting portion 20′ is integrally molded between each two extending portions 12′ of the two key bodies 10′, so the conventional key structure 100′ needs molding twice to be manufactured, in that case, the conventional key structure 100′ has a complex manufacturing process that makes the conventional key structure 100′ incapable of realizing a continuous automation. As a result, a manufacturing efficiency of the conventional key structure 100′ is low.

Thus, in order to solve the problems described above, an innovative key structure and a method for manufacturing the innovative key structure need to be provided, the innovative key structure has a simple manufacturing process and is capable of realizing a continuous automation, so that a manufacturing efficiency of the innovative key structure is high.

### SUMMARY OF THE INVENTION

An object of the present invention is to provide a key structure. The key structure includes two key bodies and two elastic pieces. The two key bodies are disposed face to face. Each of the two key bodies has a base portion. Two opposite ends of the base portion extend sideward towards a same direction to form two extending portions spaced from each other. The two extending portions of one of the two key bodies face to the two extending portions of the other key body, respectively. Two opposite ends of each of the two elastic pieces are fastened in the two extending portions of the two key bodies, respectively.

Another object of the present invention is to provide a method for manufacturing a key structure. The key structure includes two key bodies. Specific steps of the method for manufacturing the key structure are described as follows. Carry a plastic piece automatically into a mold, and the plastic piece opens a plurality of openings in advance. Mold the two key bodies to the plastic piece by adopting an integrated molding technology. Pull the two molded key bodies together with the plastic piece out from the mold, and the key structure is obtained after cutting the plastic piece together with the two key bodies.

As described above, the key structure just needs to proceed being integrally molded once by virtue of adopting the two elastic pieces to replace the elastic connecting portion integrally molded between each two extending portions of the two key bodies in prior art, and the method for manufacturing the key structure is applied in a manufacturing process of the key structure, so the key structure has a simple manufacturing process and is capable of realizing a continuous automation. As a result, a manufacturing efficiency of the key structure is high.

### BRIEF DESCRIPTION OF THE DRAWINGS

The present invention will be apparent to those skilled in the art by reading the following description, with reference to the attached drawings, in which:

FIG. 1 is a perspective view of a key structure in accordance with the present invention;

FIG. 2 is an exploded perspective view of the key structure of FIG. 1;

FIG. 3 is a diagrammatic drawing of a plastic piece, wherein the plastic piece is used in a manufacturing process of the key structure in accordance with the present invention;

FIG. 4 is a partially sectional view of the key structure in accordance with the present invention;

FIG. 5 is a diagrammatic drawing of the plastic piece, wherein the plastic piece is carried into a mold;

FIG. 6 is a perspective view of a conventional key structure in prior art; and

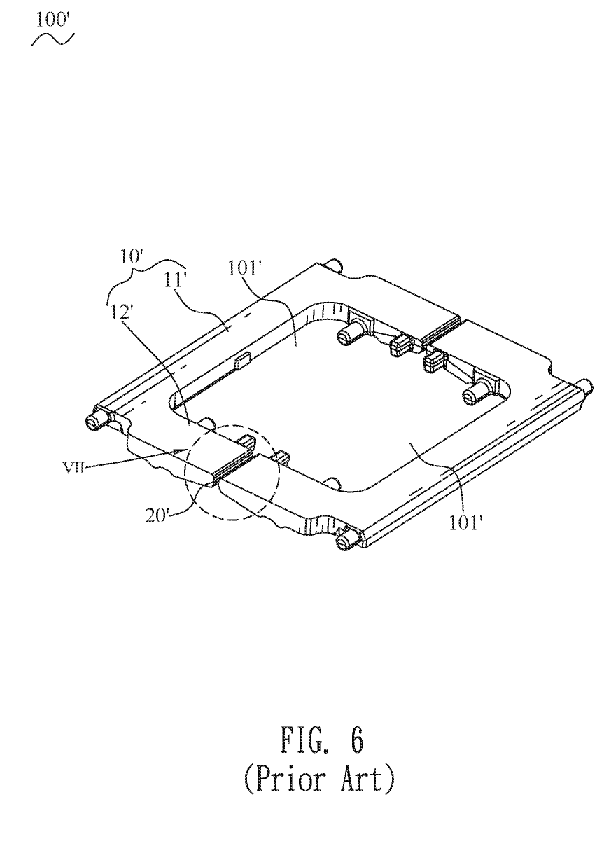

FIG. 7 is an enlarged view of an encircled portion VII of the conventional key structure of FIG. 6.

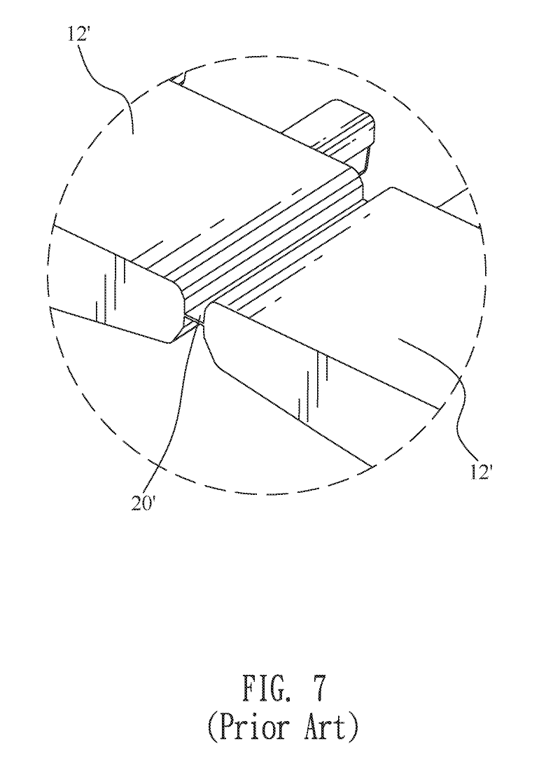

### DETAILED DESCRIPTION OF THE PREFERRED EMBODIMENT

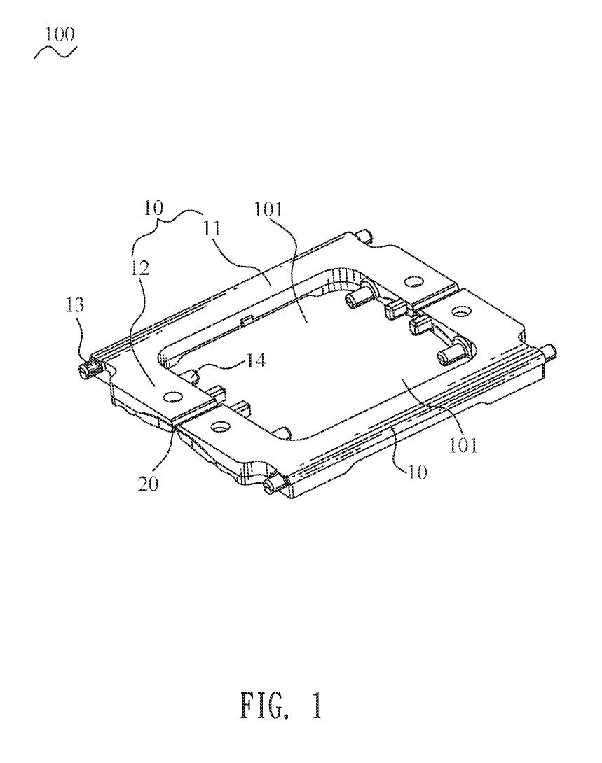

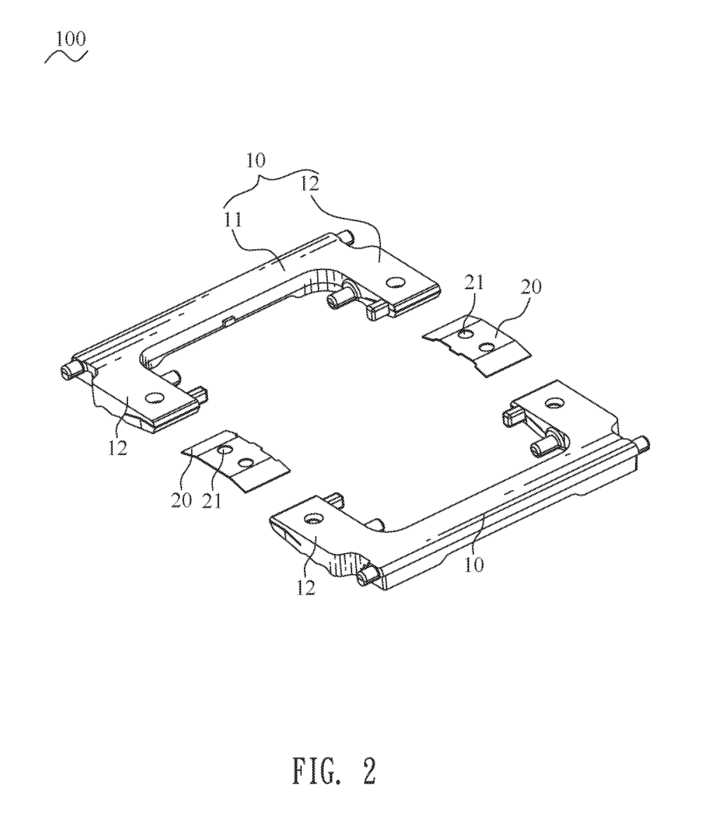

With reference to FIG. 1 and FIG. 2, a key structure 100 in accordance with the present invention is shown. The key structure 100 includes two key bodies 10 and two elastic pieces 20.

The two key bodies 10 are disposed face to face. Each of the two key bodies 10 is substantially of a U shape. Two facing sides of the two key bodies 10 are recessed oppositely to form two mouths 101 facing to each other. Each of the two key bodies 10 has a base portion 11. Two opposite ends of the base portion 11 of each of the key bodies 10 extend sideward towards a same direction to form two extending portions 12 spaced from each other. The two extending portions 12 of one of the two key bodies 10 face to the two extending portions 12 of the other key body 10, respectively. Preferably, the two extending portions 12 are perpendicular to the two opposite ends of the base portion 11, respectively.

Two opposite end surfaces of the base portion 11 of each of the two key bodies 10 protrude oppositely to form two first fastening pillars 13, respectively. The two first fastening pillars 13 are protruded outward away from the mouth 101 and extended along a direction perpendicular to an up-down direction. At least one portion of an inner surface of one of the two extending portions 12 of each of the two key bodies 10 protrudes towards the other extending portion 12 of each of the two key bodies 10 to form at least one second fastening pillar 14. At least one portion of an inner surface of the other extending portion 12 of each of the two key bodies 10 protrudes towards the one of the two extending portions 12 of each of the two key bodies 10 to form at least another one second fastening pillar 14.

The two elastic pieces 20 are of arc shapes. Preferably, middles of the two elastic pieces 20 are arched upward to form the arc shapes. Two opposite ends of each of the two elastic pieces 20 are fastened in the two extending portions 12 of the two key bodies 10, respectively to make the two key bodies 10 integrated with each other. Two sides of each of the two elastic pieces 20 have two openings 21. The two openings 21 of one of the two elastic pieces 20 are corresponding to the two extending portions 12 of the two key bodies 10 which two opposite ends of the one of the two elastic pieces 20 are fastened in, respectively. The two extending portions 12 of the two key bodies 10 are integrated with each other by virtue of the one of the two elastic pieces 20 being integrally molded between the two extending portions 12 of the two key bodies 10, so that the two key bodies 10 and the two elastic pieces 20 form a frame shape. The extending portions 12 of the two key bodies 10 are integrated with the two elastic pieces 20 tightly by virtue of the extending portions 12 of the two key bodies 10 being molded in the openings 21 of the two elastic pieces 20.

Preferably, the two extending portions 12 of the two key bodies 10 which the two opposite ends of the one of the two elastic pieces 20 are fastened in face to each other, and the two extending portions 12 of the two key bodies 10 which two opposite ends of the other elastic piece 20 are fastened in face to each other. Two sides of each of the two elastic pieces 20 have two openings 21 corresponding to the two extending portions 12 of the two key bodies 10 facing to each other, respectively. Each two extending portions 12 of the two key bodies 10 facing to each other are integrated by virtue of the one of the two elastic pieces 20 being integrally molded between each two extending portions 12 of the two key bodies 10 facing to each other, so that the two key bodies 10 and the two elastic pieces 20 form the frame shape.

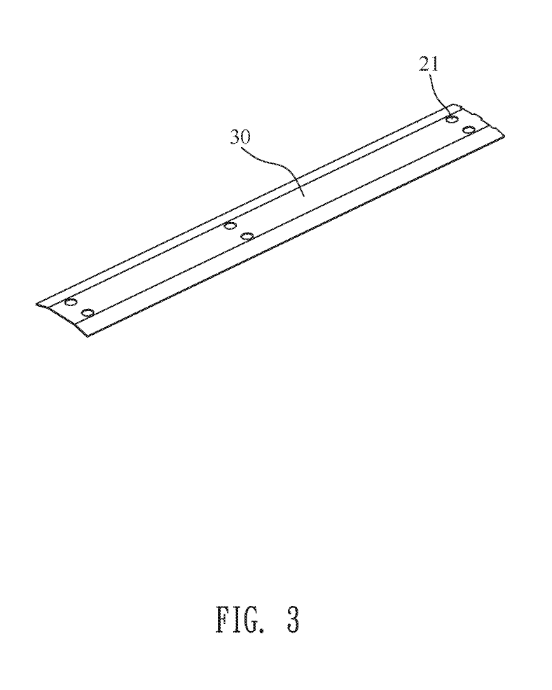

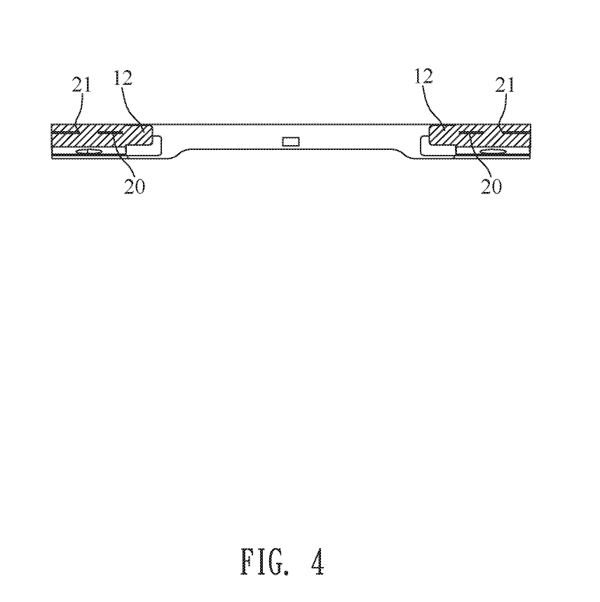

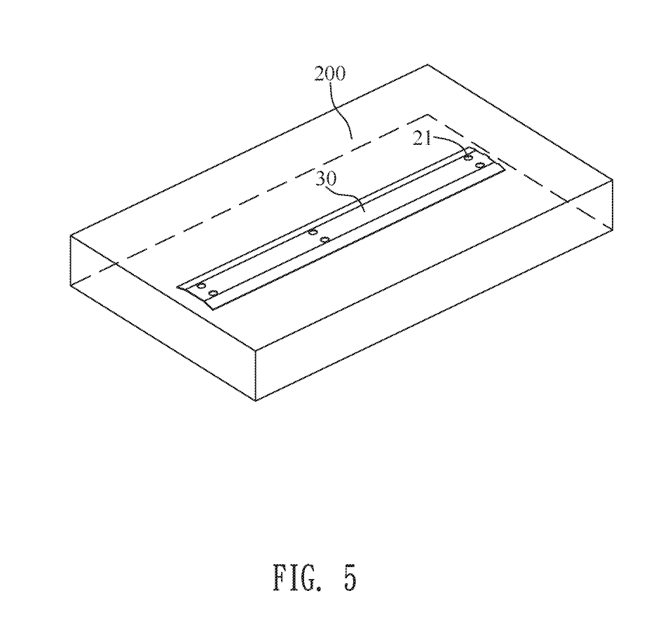

With reference to FIG. 1 to FIG. 5, a method for manufacturing the key structure 100 in accordance with the present invention is shown. The method for manufacturing the key structure 100 is applied in a manufacturing process of the key structure 100. Specific steps of the method for manufacturing the key structure 100 are described as follows. At first, carry a rectangular plastic piece 30 automatically into a mold 200 by use of a material pulling mechanism (not shown), wherein the plastic piece 30 is made of a plastic material with a better softness, and the plastic piece 30 opens a plurality of the openings 21 in advance. Then mold the two key bodies 10 to the plastic piece 30 by adopting an integrated molding technology. At last, pull the two molded key bodies 10 together with the plastic piece 30 out from the mold 200 automatically by the material pulling mechanism. A final product, namely the key structure 100 is obtained after cutting the plastic piece 30 together with the two key bodies 10. The two elastic pieces 20 are made by cutting the plastic piece 30. The plastic piece 30 is continued being pulled into the mold 200 by the material pulling mechanism to proceed manufacturing a next key structure 100 after completing manufacturing a previous key structure 100.

As described above, the key structure 100 just needs to proceed being integrally molded once by virtue of adopting the two elastic pieces 20 to replace the elastic connecting portion 20′ integrally molded between each two extending portions 12′ of the two key bodies 10′ in prior art, and the method for manufacturing the key structure 100 is applied in the manufacturing process of the key structure 100, so the key structure 100 has a simple manufacturing process and is capable of realizing a continuous automation. As a result, a manufacturing efficiency of the key structure 100 is high.

What is claimed is:

1. A key structure, comprising:
two key bodies disposed face to face, each of the two key bodies having a base portion, two opposite ends of the base portion extending sideward towards a same direction to form two extending portions spaced from each other, the two extending portions of one of the two key bodies facing to the two extending portions of the other key body, respectively; and
two elastic pieces, two opposite ends of each of the two elastic pieces being fastened in the two extending portions of the two key bodies, respectively.

2. The key structure as claimed in claim 1, wherein two sides of each of the two elastic pieces have two openings, the two openings of one of the two elastic pieces are corresponding to the two extending portions of the two key bodies which two opposite ends of the one of the two elastic pieces are fastened in, respectively.

3. The key structure as claimed in claim 2, wherein the extending portions of the two key bodies are integrated with the two elastic pieces tightly by virtue of the extending portions of the two key bodies being molded in the openings of the two elastic pieces.

4. The key structure as claimed in claim 1, wherein the two extending portions of the two key bodies facing to each other fasten two opposite ends of one of the two elastic pieces, and the other of the two extending portions of the two key bodies facing to each other fasten two opposite ends of the other elastic piece.

5. The key structure as claimed in claim 4, wherein two sides of each of the two elastic pieces have two openings corresponding to the two extending portions of the two key bodies facing to each other, respectively.

6. The key structure as claimed in claim 4, wherein each two extending portions of the two key bodies facing to each other are integrated by virtue of one of the two elastic pieces being integrally molded between each two extending portions of the two key bodies facing to each other, so that the two key bodies and the two elastic pieces form a frame shape.

7. The key structure as claimed in claim 1, wherein two opposite end surfaces of the base portion protrude oppositely to form two first fastening pillars, respectively.

8. The key structure as claimed in claim 1, wherein at least one portion of an inner surface of one of the two extending portions of each of the two key bodies protrudes towards the other extending portion of each of the two key bodies to form at least one second fastening pillar, at least one portion of an inner surface of the other extending portion of each of the two key bodies protrudes towards the one of the two extending portions of each of the two key bodies to form at least another one second fastening pillar.

9. The key structure as claimed in claim 1, wherein each of the two key bodies is substantially of a U shape, two facing sides of the two key bodies are recessed oppositely to form two mouths facing to each other.

10. The key structure as claimed in claim 1, wherein the two extending portions of the two key bodies are integrated with each other by virtue of one of the two elastic pieces being integrally molded between the two extending portions of the two key bodies, so that the two key bodies and the two elastic pieces form a frame shape.

11. A method for manufacturing a key structure, the key structure including two key bodies, comprising steps of:
carrying a plastic piece automatically into a mold, and the plastic piece opening a plurality of openings in advance;
molding the two key bodies to the plastic piece by adopting an integrated molding technology; and
pulling the two molded key bodies together with the plastic piece out from the mold, and the key structure being obtained after cutting the plastic piece together with the two key bodies.

12. The method for manufacturing the key structure as claimed in claim 11, wherein the plastic piece is made of a plastic material with a better softness.

13. The method for manufacturing the key structure as claimed in claim 11, wherein the plastic piece is continued being pulled into the mold to proceed manufacturing a next key structure after completing manufacturing a previous key structure.

14. The method for manufacturing the key structure as claimed in claim 11, wherein the key structure further includes two elastic pieces, the two key bodies are disposed face to face, each of the two key bodies has a base portion, two opposite ends of the base portion extend sideward towards a same direction to form two extending portions spaced from each other, the two extending portions of one of the two key bodies face to the two extending portions of the other key body, respectively, two opposite ends of each of the two elastic pieces are fastened in the two extending portions of the two key bodies, respectively.

15. The method for manufacturing the key structure as claimed in claim 14, wherein the two extending portions of the two key bodies facing to each other fasten two opposite ends of one of the two elastic pieces, and the other of the two extending portions of the two key bodies facing to each other fasten two opposite ends of the other elastic piece.

16. The method for manufacturing the key structure as claimed in claim 15, wherein two sides of each of the two elastic pieces have two openings, the two openings of one of the two elastic pieces are corresponding to the two extending portions of the two key bodies which two opposite ends of the one of the two elastic pieces are fastened in, respectively, the extending portions of the two key bodies are integrated with the two elastic pieces tightly by virtue of the extending portions of the two key bodies being molded in the openings of the two elastic pieces.

17. The method for manufacturing the key structure as claimed in claim 15, wherein each two extending portions of the two key bodies facing to each other are integrated by virtue of one of the two elastic pieces being integrally molded between each two extending portions of the two key bodies facing to each other, so that the two key bodies and the two elastic pieces form a frame shape.

18. The method for manufacturing the key structure as claimed in claim 14, wherein the two elastic pieces are made by cutting the plastic piece.

19. The method for manufacturing the key structure as claimed in claim 11, wherein each of the two key bodies is substantially of a U shape, two facing sides of the two key bodies are recessed oppositely to form two mouths facing to each other.
